(19) United States
(12) Patent Application Publication
(10) Pub. No.: US 2013/0258472 A1
(43) Pub. Date: Oct. 3, 2013

(54) PROTECTIVE DEVICE FOR TOUCH-FREE, IN PARTICULAR OPTICAL PROBE HEAD AND OPERATING METHOD

(71) Applicant: SMARTRAY GMBH, WOLFRATSHAUSEN (DE)

(72) Inventor: Hans Ritzl, Munsing (DE)

(73) Assignee: SmartRay GmbH, WOLFRATSHAUSEN (DE)

(21) Appl. No.: 13/855,357

(22) Filed: Apr. 2, 2013

(30) Foreign Application Priority Data
Apr. 2, 2012 (DE) 102012102830.3

(51) Int. Cl. G02B 27/00

(52) U.S. Cl. CPC G02B 27/0006
USPC 359/507

(57) ABSTRACT

In an optical probe head 1 which is configured to check a weld or a glue joint immediately after being produced there is a risk of contaminating the probe head through the production process of the joint. In order to prevent this protective devices are proposed according to the invention that are configured either as a rotor 33 rotating in front of the windows 8, 9 of the probe head 1 or as a transparent protective device arranged in front of the windows 8, 9 of the probe head 1, for example a transparent protective foil 16 that is being moved along.

### I. FIELD OF THE INVENTION

The invention relates to a protective device for a touch-free, in particular optical probe head and to a method for operating the protective device.

Subsequently, an optical probe head is always recited in the instant application, even when the probe head operates touch-free, but not according to an optical method, thus for example when it transmits invisible electromagnetic radiation so that the patent protection is not limited to an optical probe head.

### II. TECHNICAL BACKGROUND

Optical probe heads are known which, when mounted for example at a robotic arm, are used for checking for example welds or solder joints or glue joints. Thus, the optical probe head operates touch-free according to a 2D or 3D method and preferably through a light section triangulation method. Thus, a light beam is emitted through an outlet window of the probe head, wherein the light beam, after reflection at the surface to be examined, enters the probe head again through an inlet window and is evaluated in the probe head.

Thus, when the optical evaluation is performed directly during or after generating the weld or solder joint or glue joint, there is the problem that the optical probe head is contaminated by spray material during welding, soldering or gluing.

This generates a conflict in that on the one hand side, testing a production result shall be performed as close as possible to the manufacturing process and thus as quickly as possible in order to detect voids as quickly as possible; on the other hand side, this makes the risk of contaminating the inlet window and/or the outlet window of the optical probe head even greater.

### a) Technical Object

Therefore it is an object of the invention to provide a device to protect an optical probe head against contamination, wherein the protective device is configured to be manufactured in a simple and cost effective manner and requires low maintenance.

### b) Solution

The object is achieved through the features of the claims 1 and 11. Advantageous embodiments can be derived from the dependent claims.

Within the scope of the present invention two solutions are described which are configured differently but which are used for achieving the same technical object.

A first option for a protective device against contamination includes a rotor which rotates in front of the inlet window and/or outlet window, for example with a rotation axis between the two windows, so that both windows are covered by the same propeller viewed in beam direction.

The rotor arms are thus made from non-transparent material. The rotor which is driven to rotate and which is continuously detected with respect for its rotation position, however, is in direct connection with the control of the optical probe head and the particular shots which respectively only take milliseconds are taken at points in time when a gap between sequential rotor blades of the rotating rotor is arranged in front of the respective window.

Thus, the speed of the rotor in combination with the slant angle of the rotor blades and their extension in circumferential direction is sized with reference to the approach velocity of a contaminating particle so that a contaminating particle cannot penetrate the rotor, but impacts a rotor blade and is propelled outward from the rotor for example through centrifugal force. There special capture surfaces for such contamination can be provided or an impact on surrounding components is accepted. For this purpose, the speed of the rotor is between 2,000 and 4,000 rpm, better between 2,500 and 3,500 rpm.

The rotor can have the shape of a propeller in which the particular rotor blades radially extend from the rotor axis either precisely in a radial plane or at a slant angle to the rotation axis.

Thus, it can be a flat or a conical rotor in which the rotor blades are arranged at an angle of less than 90° relative to their rotation axis.

The rotor, however, can also be configured pot shaped in that the rotor blades extend from an edge of a rotating, preferably closed rotor plate in an axial manner, in particular parallel to the rotation axis of the rotor plate. A pot shaped rotor of this type can rotate in front of the side with the inlet- and outlet window of the optical probe head or the optical probe head can be arranged in an interior of the pot.

In addition, the rotor blades are preferably configured or adjusted so that they cause airflow away from the probe head and thus an approaching contaminant particle may not reach the rotor anymore, but is rather previously deflected to a radial side.

Airflow of this type can also be generated by separate, for example compressed air nozzles which also reduce the probability of contaminant particles impacting a rotor blade. Such compressed air nozzles can be attached at the rotor or at the housing of the probe head.

Thus, the rotor besides the portion of the windows to be covered can be covered by an additional, preferably dedicated protective housing which substantially protects the rotor against mechanical damage and contamination.

As a second option, in particular the inlet window, for example for the laser beam, typically arranged proximal to the object to be scanned, if necessary also the outlet window that is arranged further away, is protected against contamination through a quickly changeable, possibly also automatically exchangeable beam transparent, in particular transparent protective device for which independent patent protection is requested.

This can be a simple, insertable transparent plate which can be quickly changed manually upon contamination and which hardly expands the dimensions of the probe head.

However, when frequent and ongoing contamination is expected, solutions are preferred in which removing the contaminated portions of the protective device is performed automatically, in particular without interrupting operations of the optical probe head.

This can be for example a band made from a transparent foil which is pulled along in front of the protective window and which is transported forward, either as soon as contamination is detected in front, or which is pulled ahead continuously as a matter of principle, for example in that the band is wound off from a storage roller and the contaminated foil is wound up again on the other side of the window on a wind up roller, wherein the wind up roller is drivable by a motor in a controlled manner.

An arrangement of this type including a storage roller and a windup roller with a transparent foil can be produced as a cassette which is then simply placed onto the housing of the optical probe head and interlocked so that it is replaceable very easily.

In case contamination of the transparent protective device shall be detected in particular and the radiation transparent protective device shall not be exchanged continuously or as a precautionary measure in fixed time intervals the protective device can be illuminated from the side of the optical sensor in order to determine contamination with a light source, for example a light emitting diode, so that this light radiates outward through the protective device when the protective device is not contaminated, but is reflected back to the optical sensor at the contaminated portions in contaminated condition so that contamination can be detected at the optical sensor.

For operations of the optical probe head, a light source of this type typically is not harmful, since the optical probe head includes an optical filter in front of the optical sensor anyhow, wherein the optical sensor only passes the wavelength of the laser light through. Then the illuminated protective device is arranged preferably in the portion between the optical filter and the optical sensor of the optical unit.

When using the first option from a method point of view, care has to be taken that the speed and rotation position of the rotor is timed to the points in time of transmitting and receiving light beams by the optical probe head, for example with a common control, so that the emitted and incoming light beams can precisely pass through the gaps between the rotor blades of the rotating rotor.

Additionally, the rotor shall have a speed that is high enough so that a contaminant particle moving towards the optical probe head cannot penetrate the rotor but is either deflected far enough by the air flow generated by the rotor, so that it does not impact the rotor or in case of reaching the rotor impacts a rotor blade and cannot penetrate a gap there between. Also for this purpose, the relationship between the velocity of the rotor blade, its dimension and the impact velocity of the contaminant particle is relevant and needs to be considered.

In order to minimize the risk of the contaminant particles passing through the rotor, gaps between the rotor blades are selected as small as possible.

### c) EMBODIMENTS

Embodiments of the invention are subsequently described in more detail with reference to drawing figures, wherein:

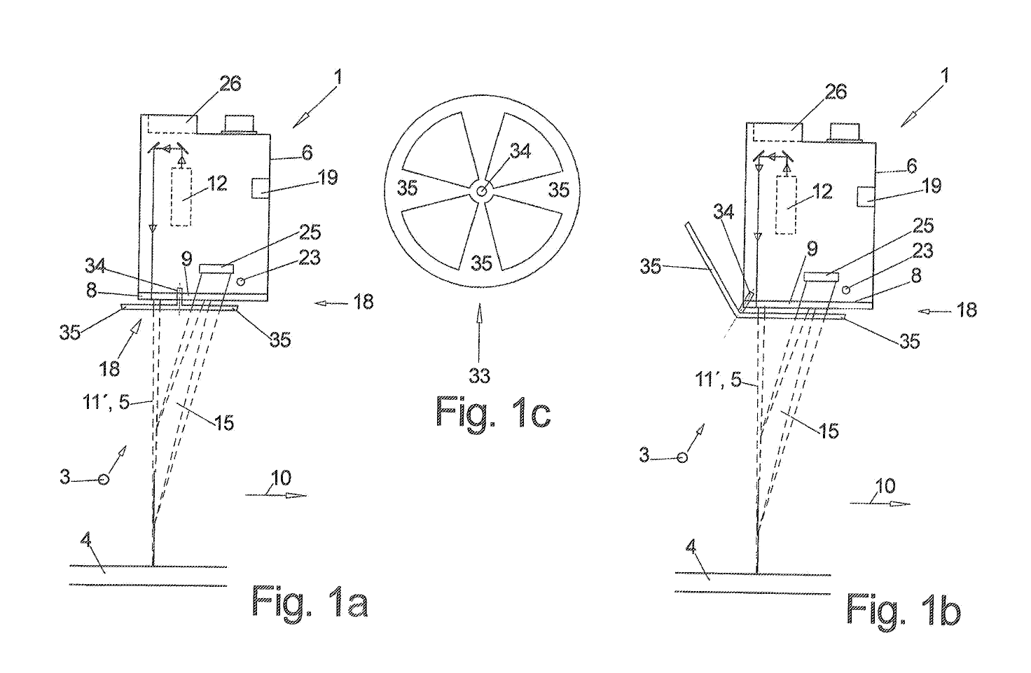

FIG. 1a-c illustrates an arrangement with a simple rotor;

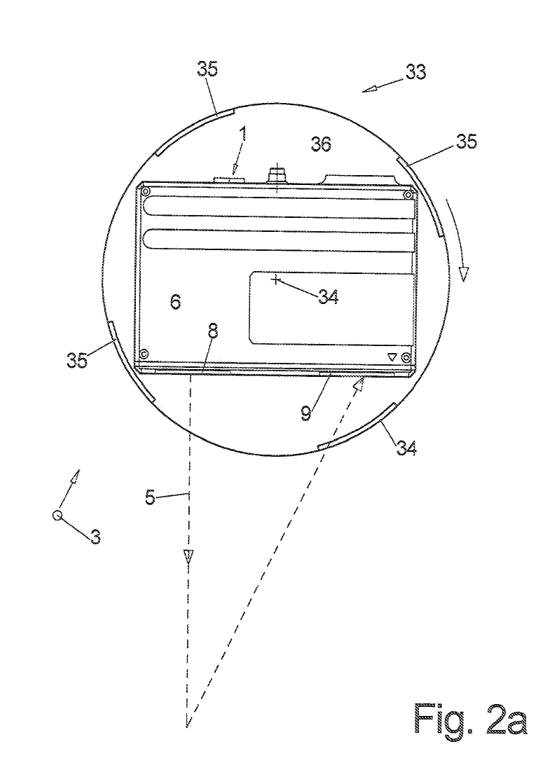

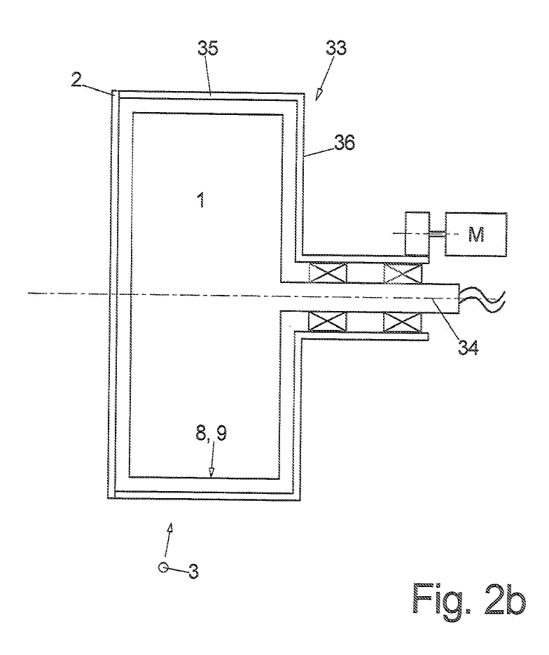

FIG. 2a, b illustrates a first arrangement with a pot shaped rotor;

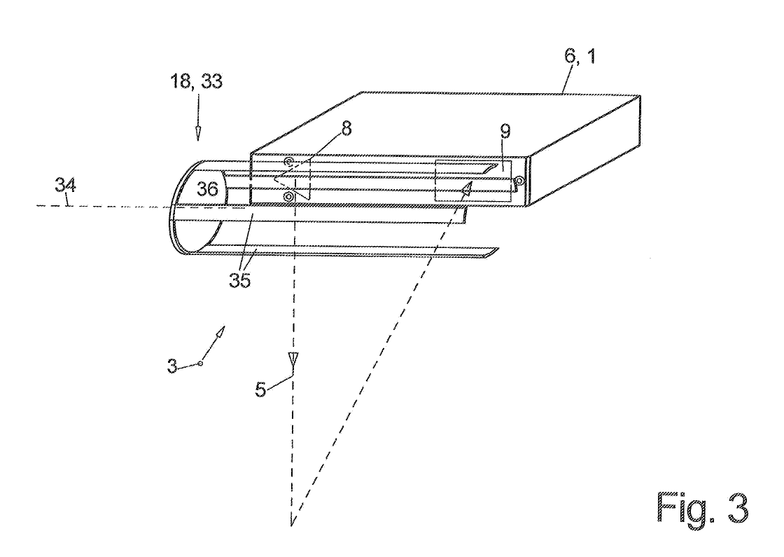

FIG. 3 illustrates a second arrangement with a pot shaped rotor;

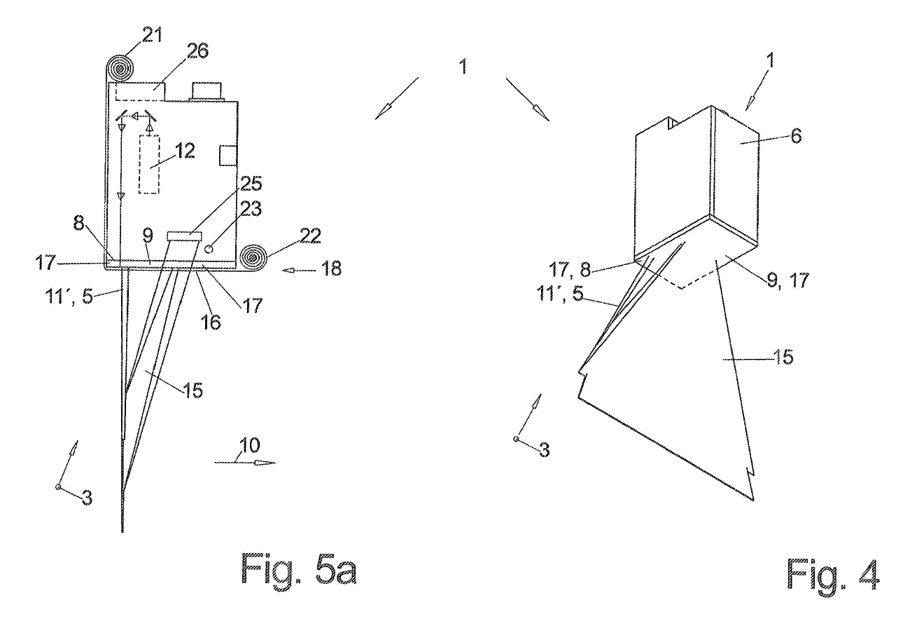

FIG. 4 illustrates an arrangement with replaceable plates;

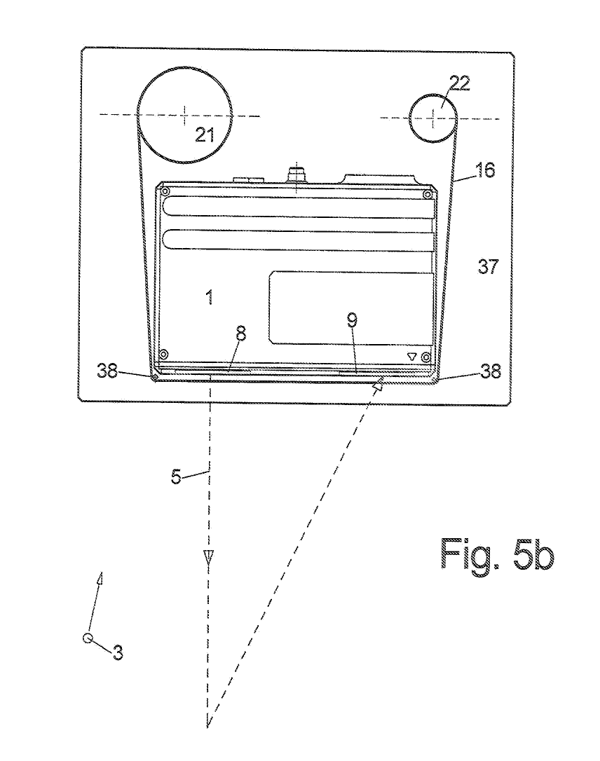

FIG. 5a, b illustrates an arrangement with a windable foil.

FIGS. 1a, b illustrate two embodiments of a protective device 18 which includes a rotor 33 rotating as illustrated in FIG. 1c in front of the outlet window 8 and the inlet window 9 of an optical test head 1 driven by a not-illustrated, controlled motor, wherein it does not matter in principle how the housing 6 of the optical probe head is shaped,

In this case, the rotor 33 has a classical shape in which the rotor blades 35 radially extend from the rotor axis 34. The free ends of the rotor blades 34 are thus connected with one another through an outer ring for improving stability, which however is not mandatorily required.

In both cases, the rotor 33 is rotatably attached at the housing 6 of the optical probe head 1 and drivable in a controlled manner, thus with the rotor axis 34 between the two windows 8 and 9. The rotor can also be rotatably supported at another component outside of the housing 6.

In the solution according to FIG. 1a, the rotor blades 35 are arranged in a radial plane relative to the axis 34 and rotate at a small distance from the side of the housing and parallel to the side of the housing, in which the outlet window 8 and the inlet window 9 is arranged.

In the solution according to FIG. 1b, the rotor blades 35 protrude at a slant angle from the rotation axis 34, thus with an acute angle there between. The rotation angle is arranged on the one hand side at a small distance from the side of the housing, in which the inlet window 9 is arranged and the rotation cone extends at a slant angle to the other adjacent side of the housing. This prevents an excessive lateral protrusion beyond the sidewall of the housing.

This embodiment is helpful when the outlet window 8 and the inlet window 9 are not in the same plane, for example not arranged in the same wall of the housing 6.

However, the only important thing is that the two variants of the rotor blades 35 are sufficiently long in order to cover both windows 8, 9 in radial direction.

FIGS. 2a, b and 3 illustrate embodiments with a rotor 33 shaped according to a different principle.

This rotor includes a preferably closed rotor disc 36 which rotates about a rotor axis 34 which is arranged perpendicular to the plane of the rotor disc 36. The rotor blades 35 protrude from the edge of the typically circular rotor disc 36 in an axial direction, thus extending parallel to the rotor axis 34.

With reference to an approximately rectangular housing 6 of an optical probe head 1, the preferred case is illustrated in FIG. 2a, b where the optical probe head 1 is positioned with the housing 6 in a pot shaped interior of the rotor 33 and the length of the rotor blades 35 is at least sized so that the direction of its extension covers at least the outlet window 8 and the inlet window 9 of the optical probe head 1. Preferably the entire probe head 1 can be placed in the interior of the pot shaped rotor 33.

Depending on the shape of the housing 6, this yields a very space saving solution, wherein the open side of the pot shaped rotor 33 may be closeable entirely or partially by a stationary cover 2 and thus an additional protection of the optical probe head 1 against contamination is provided.

FIG. 3 illustrates a solution in which the optical probe head 1 is not arranged in an interior of the pot shaped rotor 33, but the pot shaped rotor rotates at a distance from the side of the housing 6 in which the outlet window 8 and the inlet window 9 are arranged. This solution is advantageous for example for very flat, plate shaped housings 6 of the optical probe head 1.

Also here the diameter of the rotor disc 36 and the length of the rotor blades 35 has to be sized so that they completely cover the housing side with the outlet window 8 and the inlet window 9 during rotation.

In all cases, it is preferably intended that during the time period of a measurement which only amounts to a millisecond, no rotor blade 35 passes in front of the windows 8, 9, but a respective gap is arranged in front of both windows 8, 9, preferably the same gap is arranged between two rotor blades 35.

Thus the speed of the rotor 33 has to be defined as a function of the dimensions of the rotor blades 35 and the positioning of the rotor 33 relative to the optical probe head 1 has to be determined so that no rotor blade 35 penetrates the portion in front of a window during a measurement period and on the other hand side the speed of the rotors 33 has to be set high enough, so that a contaminant particle 3 moving towards the rotor 33 typically with a known flight velocity cannot move through the gap between two rotor blades 35 but always impacts a rotor blade 35 and is thrown off by the rotor blade 35.

This can be additionally supported through a respective cross-sectional shape of the rotor blades 35, for example like an aircraft wing with a profile which generates an airflow that is oriented away from the rotor 33 and/or through an airflow generated by jets and compressed air which also guides the approaching contaminant particles away from the windows 8, 9.

Compressed air nozzles of this type are preferably arranged at the housing 6 of the optical probe head 1, but the air nozzles can also be arranged at the rotor 33. Their particular positioning strongly depends from the shape of the housing 6 and the shape of the rotor 33 that is being used.

A single optical probe head 1 with a differently shaped housing 6 and with a different type of protective device 18, namely a non-rotating configuration is illustrated in FIGS. 4 and 5a and 5b and thus in FIG. 5a precisely with a view of the transversal plane 11′ which is arranged orthogonal to the driving direction 10.

The optical probe head 1 of FIGS. 4 and 5a is arranged in a housing 6 in whose one side wall the outlet window 8 and the inlet window 9 are arranged.

In the interior of the housing 6 a typically elongated laser light source 12 is arranged and the laser beam 5 exiting therefrom in upward direction is deflected by 2 deflection mirrors by 2×90° so that it exits through the outlet window 8 and is oriented in the transversal plane 11 fanned into a fan 5 arranged in this plane against the object to the scanned, for example a glue bead 4 as illustrated in FIG. 1a and is reflected from its surface.

The reflected and also fanned beam 15 is received by an optical sensor 25, for example a COD sensor that is arranged in an interior of the housing 6 behind the inlet window 9.

Thus the inlet window 9 is arranged in a bottom side of the housing 6 adjacent to the outlet window 8.

Both windows are secured against permanent contamination through a second embodiment of the protective device 18.

According to FIG. 4 this can be insertion plates 17 that are insertable in front of the particular windows 8, 9 and therefore easily replaceable made from material transparent for laser light wherein the insertion plates are exchanged after contamination.

Since this is manual labor which leads to an interruption of the use of the probe head 30 the automatically operating protective device 18 illustrated in FIG. 5a is preferable.

Thus, a foil 16 that is transparent for the laser beam is moved in front of the outlet window 8 and/or the inlet window 9, preferably past one after another in this sequence, so that occurring contaminations are deposited on this foil 16.

The foil 16 can be stored on a storage roller 21 and can be wound further onto a wind up roller 22 which provides a clean uncontaminated foil 16 over a long operating period. Moving the foil 16 forward can be performed by a controlled motorized driving of the wind up roller 22 automatically and during operations.

Thus, the foil can be run within the housing 6 depending on the space required and/or the rollers 21, 22 can also be arranged in the interior of the housing and only in the portion of the windows 8, 9 the foils have to be arranged and supported outside of the housing.

However, it is advantageous for exchanging the foil 16 to attach their supports and also their rollers 21, 22 on the outside of the housing of the optical probe head 1.

Thus FIG. 5 illustrates a solution in which the rollers 21, 22 and the supports 38 for the foil 16 are arranged in a cassette 37 which includes a cavity that is open on one side, corresponding to the shape of the optical probe head 1, so that the cassette 37 can be placed and interlocked on the probe head 1, so that the foil 16 is precisely positioned in front of the windows 8, 9.

### REFERENCE NUMERALS AND DESIGNATIONS

1 optical probe head
2 cover
3 contaminant particle
4 bead
5 laser beam, fan
6 housing
7 shoulder
8 outlet window
9 inlet window
10 driving direction
11′ plane, transversal plane
12 laser light source
15 reflected beam
16 foil
17 insertion plate
18 protective device
19 control
21 storage roller
22 wind up roller
23 light source
25 optical sensor
26 processing electronics
33 rotor
34 rotor axis
35 rotor blade
36 rotor disc
37 cassette
38 supports

1. A protective device for a touch free, optical probe head (1) transmitting electromagnetic radiation, in particular light beams from an outlet window (8) and/or receiving them through an inlet window (9) for testing purposes caused by a control, which protective device (18) comprises:
a rotor (33) with rotor blades (35) that is drivable in a controlled manner and which rotates in front of the outlet window (8) and/or the inlet window (9) and is driven so that a pass through of the light beam and/or of the reflected beam occurs in a time coordinated manner exactly in the intermediary space between two sequential rotor blades (35) of the rotating rotor (33) and a drive and a rotation position detection of the rotor (33) is coupled with the control of the optical probe head (1).

2. The protective device according to claim 1, wherein the rotor blades (35) are configured or slanted so that an air flow in a direction towards the object to be scanned is caused, thus away from the optical probe head (1).

3. The protective device according to claim 1, wherein the speed of the rotor (33) relative to the size of the rotor (33) is high enough, so that contaminant particles cannot penetrate the rotor and in particular contaminant particles impacting the rotor blade (35) are flung off radially and cannot adhere, and in particular the speed of the propeller (33) is between 2000 and 4000 RPM, better between 2500 and 3500 RPM.

4. The protective device according to claim wherein the rotor axis (34) is arranged between the inlet window (9) and the outlet window (8) of the probe head (1) and the rotor (33) covers both windows.

5. The protective device according to claim 1, wherein the rotor blades (35) are arranged at an angle <90° relative to the rotor axis (34).

6. The protective device according to claim 1, wherein the rotor blades (35) extend from an edge of a rotor disc (36) or of a rotor ring parallel to the rotor axis (34) and the rotor blades (35) rotate in front of the inlet window (9) and the outlet window (8) and in particular the rest of the optical probe head is within the rotation circle of the rotor blades (35), preferably proximal to the rotor disc (36).

7. A protective device for a touch free, in particular optical probe head (1) transmitting electromagnetic radiation, in particular light beams from an outlet window (8) and/or receiving them through an inlet window (9) for testing purposes caused by a control, comprising:
at least the inlet window (9) and/or the outlet window (8) of the probe head (1) is protected by a radiate able, in particular transparent protective device (18).

8. The protective device according to claim 7, wherein the protective device (18) is an insertion plate (17) and/or a foil (16) that is windable in particular which is transported from a storage roller (21) on one side to a wind up roller (22) on another side of the respective window (8, 9) wherein at least the wind up roller (22) is drivable by a motor in a controlled manner.

9. The protective device according to claim 7, wherein the foil (16) besides the portion in front of the respective window (8, 9) is supported within a housing (6), in particular the housing (6) of the optical unit (2a, b), in particular also the two rollers (21, 22) for the foil (16) are arranged within a housing (6).

10. The protective device according to claim 7, wherein the transparent protective device (18) is illuminated from a side of the optical sensor (25) by a light source (23) so that light reflected by a non transparent deposit on a front side of the protective device (18) reaches the optical sensor (25).

11. A method for using a protective device, according to claim 1 comprising the following steps:
permanently reporting the rotation of the rotor (33) with respect to speed and rotation position to the control,
controlling transmitting and/or receiving light beams through the control time based so that light beams run precisely through the gaps between the rotor blades (35).

12. The method according to claim 11, wherein the rotor (33) is rotated fast enough so that a contaminant particle moving towards the optical probe head (1) cannot penetrate the rotor (33), but impacts the rotor (33) and adheres to the rotor or is thrown off from the rotor in outward direction.

13. The method according to claim 11, wherein the rotor blades (35) are shaped or adjusted so that they generate an air flow that is oriented away from the rotor (33).

14. The method according to claim 11, wherein the gaps between the rotor blades (35) are sized as small as possible.
